(19) United States
(12) Patent Application Publication
(10) Pub. No.: US 2020/0255269 A1
(43) Pub. Date: Aug. 13, 2020

(54) WINCH APPARATUS HAVING AUTOMATIC TENSION FUNCTION

(71) Applicant: URAKAMI LLC, Kanagawa (JP)

(72) Inventor: Fukashi URAKAMI, Kanagawa (JP)

(21) Appl. No.: 16/861,324

(22) Filed: Apr. 29, 2020

Related U.S. Application Data
(63) Continuation of application No. PCT/JP2018/040920, filed on Nov. 4, 2018.

(30) Foreign Application Priority Data
Nov. 10, 2017 (JP) 2017-217599

(51) Int. Cl. B66D 1/50; B63B 21/56

(52) U.S. Cl. CPC B66D 1/50; B66D 2700/0108; B63B 21/56

(57) ABSTRACT

The three operations of hoisting, hoisting, and stopping are automatically performed by using the pulley and the position sensor, so that the general-purpose winch can be easily provided with the auto-tension function. The present invention provides the winch that is inexpensive and has the short delivery time. The three operations of hoisting, hoisting, and stopping are automatically performed by using the pulley and the position sensor, so that the general-purpose winch can be easily provided with the auto-tension function. In two pulleys where wire rope is suspended, the distance between the pulleys can be to changed according to the tension of the wire rope; if the tension increases, the distance between the pulleys decreases and the position sensor operates. As the result, the winch turns to a lowering motion, and the distance between the pulleys increases due to the action of the force of the rodless cylinder; if the tension decreases, the distance between the pulleys increases and another position sensor operates. Therefore, the winch turns into the winding operation and the distance between the pulleys is reduced; the wire rope returning operation and the wire rope pulling operation described above are repeatedly performed due to the operation of the two position sensors, so that the wire rope controls the tension of the constant tension.

### CROSS-REFERENCE TO RELATED APPLICATIONS

This is a continuation application of a prior PCT application No. PCT/JP/2018/040920 filed on Nov. 4, 2018.

### TECHNICAL FIELD

This invention belongs to the field of a hoisting device that rotates a drum to wind a rope around the drum or unwinds from the drum, or an endless winch in which a rope is pulled or returned using frictional force such as pinching the rope with claws. Hereinafter, the hoisting device or the endless winch is referred to as the winch unit.

This invention relates to a “winch apparatus having automatic tension function” incorporated with the winch unit, that is referred to as the auto-tension winch.

The auto-tension winch has a function of automatically adjusting the tension of the rope so that the rope does not slack and the rope does not become too tight when the auto-tension winch is operating.

### BACKGROUND OF THE INVENTION

As for an example of a publicly-known technology of the auto-tension winch, the auto-tension winch having the auto-tension function is described in Japanese Patent Publication No. H5-8768.

The auto-tension winch prevents the wall cleaning robotic crawler from falling.

The wall cleaning robotic crawler can adhere to a wall surface and travel along the wall surface such as a building by utilizing negative pressure, and that can clean the wall surface or remove degraded paint, etc. from the wall surface.

Japanese Patent Publication No. H5-8768 discloses the following as an application example of the auto-tension winch in the wall cleaning robotic crawler.

“The wall cleaning robotic crawler is suspended by a pair of auto-tension winches 50.

The pair of auto-tension winches 50 are set to such an extent that the tension is not slackened on the rope 51 and does not hinder the running of the robotic crawler 1.

The tension of the auto tension winches 50 supports all or a part of the weight of the robotic crawler 1.

In the embodiment of this patent application, if the weight of the robotic crawler 1 is 290 kg, the predetermined tension of the auto-tension winch 50 is 50 kgf to 20 kgf, and the wire rope 51 is always operated in the winding direction when the auto-tension function is energized.

The auto tension winches 50 are installed at appropriate intervals.

The robotic crawler 1 is suspended between the auto tension winches 50 and the wire ropes 51 are suspended on pulleys 52 arranged on the rooftop.
The ends of the two wire ropes are connected to hanging brackets 3 fixed to the main body 10 of the robotic crawler 1.

Although the auto-tension winches 50 suspend the robotic crawler 1, the auto-tension winches 50 do not actively move the robotic crawler 1 along the wall surface W.

That is, the main purpose of the auto tension winches 50 is to reduce the load on the suction cup 3 by supporting a part or all of the weight of the robotic crawler 1 so that the suction force of the suction cup 3 described later is not hindered. Therefore, the tension of the auto tension winch is set so that the wire ropes 51 do not slack and the robotic crawler 1 is not actively pulled up.

Another purpose of the auto tension winches 50 is to prevent the robotic crawler 1 from dropping due to insufficient suction force to the wall W of the robotic crawler 1 in case of power failure or the like.

As described above, the tension is set to a small value to support the own weight of the robotic crawler 1, and is mainly used for this purpose.”

In the above-described auto-tension winch that is described in Japanese Patent Publication No. H5-8768, it is extremely difficult to modify a general-purpose auto-tension winch and convert it to an auto-tension winch having the auto-tension function.

That is, in the above-described auto-tension winch that is described in Japanese Patent Publication No. H5-8768, it needs to be specially designed and specially manufactured, and thus is extremely expensive and requires a long delivery time.

Therefore, the present inventor has proposed an auto-tension winch having the following functions described in Japanese Patent Application Publication No. 2009-173391.

In the auto-tension winch having the auto-tension function, the auto-tension function can be easily added to a general-purpose auto-tension winch by automatically performing three operations of hoisting, lowering, and stopping using a displacement sensor. Therefore, it is possible to achieve a low cost and a short delivery time.

The outline of the auto-tension winch described in Japanese Patent Application Publication No. 2009-173391 is as follows.

“In the auto-tension winch having the auto-tension function described in Japanese Patent Application Publication No. 2009-173391, the auto-tension winch is at least composed of a winch unit including a rotary drum for winding a rope and an actuator for driving the rotary drum, and is composed of a rotating shaft that allows the winch unit to swing on a plane that intersects with the rotating shaft of the rotary drum, and is composed of displacement sensors for detecting a threshold value of the swing displacement of the winch unit.

The operation of the above auto-tension winch having the auto-tension function is as follows.

The rotary drum winds the rope when the winch unit does not swing due to the low tension of the rope and thus the displacement sensor does not detect the threshold value of the swing displacement.

When the tension of the rope increases due to the winding of the rope, the winch unit swings, and the rotation of the rotary drum stops when the displacement sensor detects a threshold value of the swing displacement for the swing operation;

The winch unit swings due to an increase in the tension of the rope, and thus, when the displacement sensor detects the threshold value of the swing displacement, the rotating drum rewinds the rope.

When the rope tension is reduced by winding the rope, the winch unit swings in the opposite direction, and when the displacement sensor detects the threshold value of the swing displacement due to the swing operation, the rotation of the rotary drum stops;

In the above auto-tension winch,

The rope tension acts in the same direction as the direction in which the circumference of the rotating drum is to be rotated.

In order to prevent the winch unit from swinging or rotating due to the action, an actuator such as a coil spring, a mainspring-type spring, or a rotary actuator is mounted on the auto-tension winch.

Further, the auto-tension winch includes a first displacement sensor for detecting a small swing displacement of the winch unit and a second displacement sensor for detecting a large swing displacement of the winch unit.

The rotary drum winds the rope when the winch unit does not swing due to the low tension of the rope, and thus the first displacement sensor does not detect the threshold value of the swing displacement. When the tension of the rope increases due to this winding operation, the winch unit swings, and the rotation of the rotary drum stops when the first displacement sensor detects a swing displacement threshold value;

When the tension of the rope further increases, the winch unit further swings, and when the second displacement sensor detects a swing displacement threshold value for the swing operation, the rotary drum rewinds the rope.

When the tension of the rope decreases due to the unwinding action, the winch unit swings in the opposite direction.
When the first displacement sensor detects the threshold value of the swing displacement due to the swing operation, the rotation of the rotating drum is stopped;

When the tension of the rope further decreases, the winch unit is further swung in the opposite direction by the force of an actuator such as the spring. When the first displacement sensor does not detect the threshold value of the swing displacement due to the swing operation, the rotating drum starts winding the rope again:

In the above-described auto-tension winch, the axis of the rotation shaft that allows the winch unit to swing on the plane that intersects with the rotation axis of the rotary drum is the same as the plane that intersects with the rotation axis of the rotation drum. It is substantially the same as the center of gravity axis of the winch body located on the orthogonal plane.”
Patent Document 1: Japanese Patent Publication No. H5-8768
Patent Document 2: Japanese Patent Publication No. 2009-173391

### SUMMARY OF THE INVENTION

In the auto-tension winch having an automatic tension function described in the above-mentioned Patent Publication No. 2009-173391, a change in the tension of the rope is converted into a change in the angle at which the winch body swings, and the operation of the displacement sensor caused by the change in the angle triggers the winding or rewinding of the rope by the winch unit, thereby realizing the auto tension function.

However, the auto-tension winch described in Japanese Patent Application Publication No. 2009-173391 has the following problems to be solved.

The first problem to be solved is that the winch body swings due to a change in the tension of the rope, but it is difficult to increase the swing angle, so that the frequency of operating the displacement sensor increases. Then, the winding operation and the rewinding operation of the winch unit are frequently repeated, and therefore, when the winch unit uses an electric motor with a brake, the wear of the brake pad may be accelerated.

Therefore, in the present invention, an auto-tension winch in which the displacement sensor operates less frequently is proposed.

As the second problem to be solved, since a mechanism for swinging a heavy winch unit is required, the size of the winch unit becomes large and heavy. It is difficult to achieve weight reduction.

Accordingly, the present invention proposes an auto-tension winch, which eliminates the need for a mechanism for swinging the winch unit and easily achieves space saving and weight reduction of the installation location of the winch unit.

In the present invention, it is possible to install a mechanism that implements the auto-tension function at a location away from the winch unit, thus making it easier to save space and reduce the weight of the winch unit.

Hereinafter, means for achieving the above object will be described. According to the present invention, the means for achieving the above object are described in claim 1 below.

“Winch Apparatus Having Automatic Tension Function” comprising:

A winch unit having a rope pulling operation, a rope returning operation, and a rope stopping operation function;

At least two pulleys disposed between the winch unit and the towed object pulled by the winch unit through a rope, the pulleys having the rope suspended on the pulleys;

A Pulley holding mechanism wherein one of the two pulleys is held by a pulley shaft via a pulley slide bearing, the pulley is rotatable by the function of the pulley slide bearing, and can slide freely along the pulley axis, and wherein the other of the two pulleys is held by another pulley shaft via a pulley slide bearing, the pulley is rotatable by the function of the pulley slide bearing, and can slide freely along the pulley axis, and wherein the distance between the two pulley axes is displaceable;

An actuator, a spring, or a weight disposed between the two pulley shafts, having a force for displacing a distance between the two pulley shafts in a direction in which the distance increases;

A rope that is suspended between the two pulleys such that as the tension of the rope increases, the distance between the two pulley axes decreases due to the increase in tension;

Displacement sensor that detects changes in distance such as a position sensor that detects a change in the distance between the two pulley shafts, or a load sensor that detects a change in the distance between the two pulley shafts as a load change;

Wherein when the tension of the rope increases, the distance between the pulleys decreases due to the increase in tension, and then the displacement sensor operates, thus causing the winch unit to return the rope.

That is, the distance between the pulleys is increased due to the rope returning operation.

Wherein when the tension of the rope decreases, the distance between the pulleys increases due to the decrease in the tension, and then the displacement sensor operates, thus causing the winch unit to pull the rope.

That is, the distance between the pulleys is decreased due to the rope pulling operation.

That is, wherein the rope return operation and the rope pulling operation described above are repeatedly performed due to the operation of the displacement sensor, thereby controlling the tension of the rope to a constant tension.

Hereinafter, another means for achieving the above object will be described.

According to the present invention, the means for achieving the above object are described in claim 2 below.

“Winch Apparatus Having Automatic Tension Function” comprising:

A winch unit having a rope pulling operation, a rope returning operation, and a rope stopping operation function;

At least two pulleys disposed between the winch unit and the towed object pulled by the winch unit through a rope, the pulleys having the rope suspended on the pulleys;

A pulley holding mechanism;

A rope suspended from the pulley such that as the tension of the rope increases, the amount of force between the pulleys increases;

A load sensor for detecting a change in the magnitude of the force of pressing the pulleys;

Wherein when the tension of the rope increases, the load sensor operates due to the increase in the tension, and the winch unit returns the rope when the load sensor operates. Then, when the rope is returned, the magnitude of the pushing force between the pulleys is reduced.

On the other hand, when the tension of the rope decreases, the load sensor operates due to the decrease in the tension. When the load sensor is actuated, the winch unit pulls the rope, thus increasing the amount of force between the pulleys due to the action of pulling the rope.

By repeatedly performing the rope return operation and the rope pulling operation due to the operation of the load sensor, the tension of the rope is controlled to a constant tension.

This invention brings about the following effects.

First, in the auto-tension winch described in Japanese Patent Application Publication No. 2009-173391, the winding operation and the rewinding operation of the winch body are frequently repeated because the displacement sensor operates frequently. However, in the present invention, the auto-tension winch in which the displacement sensor operates less frequently is realized.

Second, the auto-tension winch described in Japanese Patent Application Publication No. 2009-173391 requires a mechanism for swinging a heavy winch unit. Therefore, the size of the winch unit becomes large and heavy, and it is difficult to achieve space saving and weight reduction of the installation place of the winch unit.

However, in the auto-tension winch having the auto-tension function of the present invention, since the mechanism for swinging the winch body is not required, it is easy to achieve space saving and weight reduction of the installation place of the winch unit.

Furthermore, in the present invention, the mechanism that implements the auto-tension function can be installed at a location apart from the winch unit. Therefore, it is easy to achieve space saving and weight reduction of the installation place of the winch unit.

### BRIEF DESCRIPTION OF THE DRAWINGS

FIG. 1 is the overall view showing the device configuration of the first preferred embodiment of the device configured according to the present invention.

FIG. 2 is the top view of the first preferred embodiment of the device configured according to the present invention showing the winch unit, pulley retention mechanism and wire rope.

FIG. 3 is the right side view of the device shown in FIG. 2.

FIG. 4 is the left side view of the device shown in FIG. 2.

FIG. 5 is the partial cross-sectional view taken along the line AA of the device shown in FIG. 2.

FIG. 6 is the partial cross-sectional view taken along the line BB of the device shown in FIG. 2.

FIG. 7 is the partial cross-sectional view taken along the line CC of the device shown in FIG. 3.

FIG. 8 shows that, in the device shown in FIG. 6, two weights 8 are arranged instead of the two rodless cylinders 6, as another aspect of the first preferred embodiment of the present invention. FIG. 6.

FIG. 9 shows that, in the device shown in FIG. 6, two load cells 9 are arranged instead of the two rodless cylinders 6, as a part of the device of the second preferred embodiment of the present invention.

FIG. 10 is the overall view showing the device configuration of the second preferred embodiment of the device constructed according to the present invention.

### DETAILED DESCRIPTIONS OF THE PREFERRED EMBODIMENTS

Preferred embodiments of the device configured according to this invention will be explained in detail hereinafter referring to the accompanying drawings.

Hereinafter, the first preferred embodiment of the apparatus constituted according to the present invention will be described with reference to the accompanying drawings.

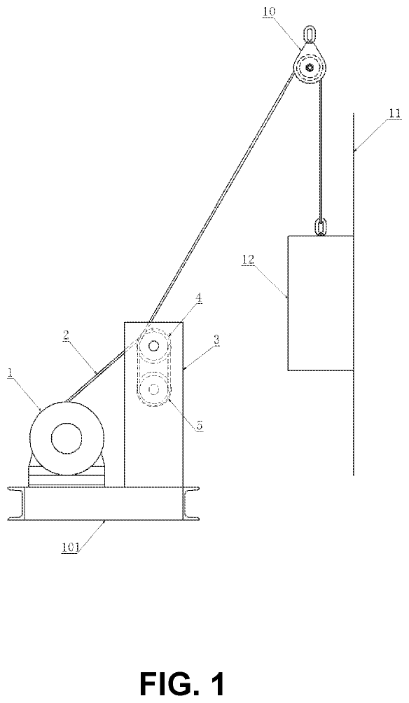

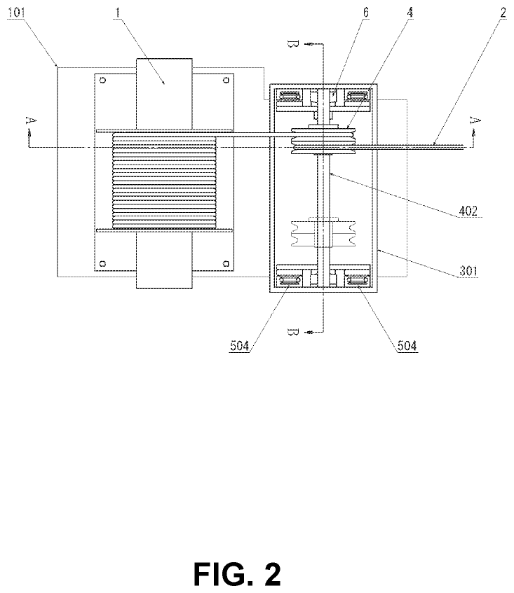

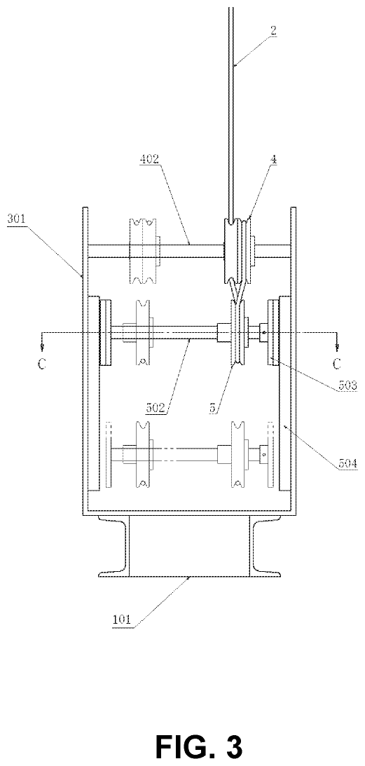

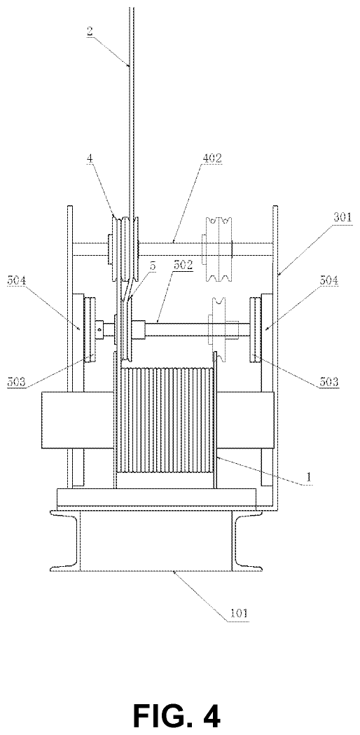

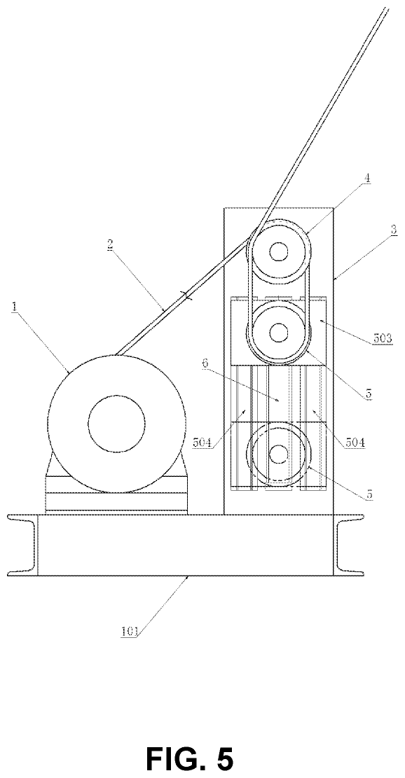

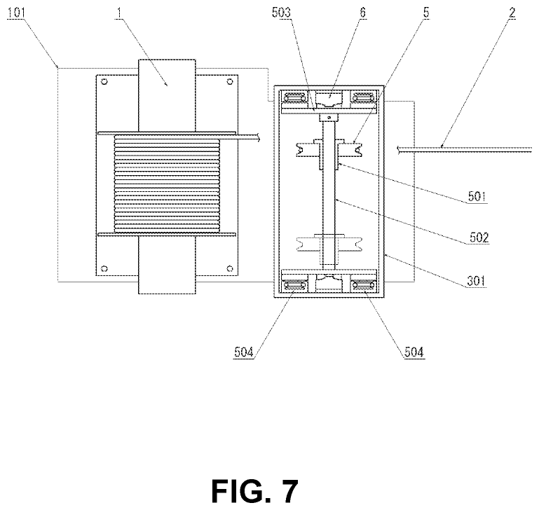

Referring to FIGS. 1 to 7, the apparatus according to the first preferred embodiment of the apparatus constructed according to the present invention comprises the following members:

That is, the names and functions of each of those members are listed in order below:

The winch unit 1 having the functions of pulling the wire rope, returning the wire rope, and stopping the wire rope;

The wire rope 2 wound on the rotating drum of the winch unit 1;

Two pulleys 4, 5 suspended in the middle of the wire rope 2 so that when the tension of the wire rope 2 increases, the distance between the pulleys decreases due to the increase in the tension;

The pulley holding mechanism 3 that holds the pulleys and can change the distance between the pulleys, and the pulley holding mechanism 3 is structured as follows;

In the pulley holding mechanism 3, the upper pulley 4 located above is held by the upper pulley shaft 402 via the upper pulley slide bearing 401,

The upper pulley 4 is rotatable by the function of the upper pulley slide bearing 401, and can slide freely in the lateral direction along the upper pulley axis 402, Each of both ends of the upper pulley shaft 402 is fixed to the side surface of the pulley holding mechanism frame 301,

The lower pulley 5 located below is held by the lower pulley shaft 502 via the lower pulley slide bearing 501,

The lower pulley 5 is rotatable and freely slidable in the lateral direction along the lower pulley shaft 502 by the function of the lower pulley slide bearing 501;

Two rodless cylinders 504 disposed between the pulleys, the pneumatic actuators having the force to displace the distance between the pulleys in the direction to increase the distance;

Two limit switches 7 arranged to detect the change in the distance between the pulleys:

Operation and effects of the above-mentioned device will be explained hereinafter.

When the tension of the wire rope 2 increases, the increase of the tension overcomes the force of the rodless cylinder 504, and thus the distance between the pulleys decreases, so that the upper limit switch 7 operates.

When the limit switch 7 operates, the winch unit 1 rewinds the wire rope 2. Thus, due to the unwinding action of the wire rope, the action of the rodless cylinder 504 increases the distance between the pulleys;

On the other hand, when the tension of the wire rope 2 decreases, the distance between the pulleys increases due to the action of the rodless cylinder 504 due to the decrease in the tension, and the lower limit switch 7 operates.

When the limit switch 7 is actuated, the winch unit 1 pulls the wire rope 2, thus reducing the distance between the pulleys due to the pulling action of the wire rope;

By repeatedly performing the above wire rope returning operation and wire rope pulling operation due to the operation of the upper and lower limit switches 7, the tension of the wire rope 2 is controlled to the constant tension.

The winch device having the auto-tension function is provided by the configuration and operation of the device of the first preferred embodiment according to the present invention as described above.

The force by which the rodless cylinder 504 increases the distance between the pulleys is smaller than the force by which the winch unit 1 decreases the distance between the pulleys.

As for the preset method of the force by which the pneumatic rodless cylinder 504 increases the distance between the pulleys, the thrust of the rodless cylinder 504 is preset by the pneumatic pressure regulator.

Hereinafter, alternative embodiments of the first preferred embodiment of the apparatus constituted according to the present invention will be described with reference to the accompanying drawings.

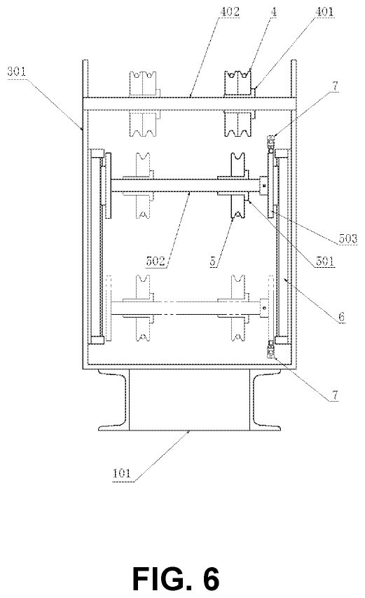

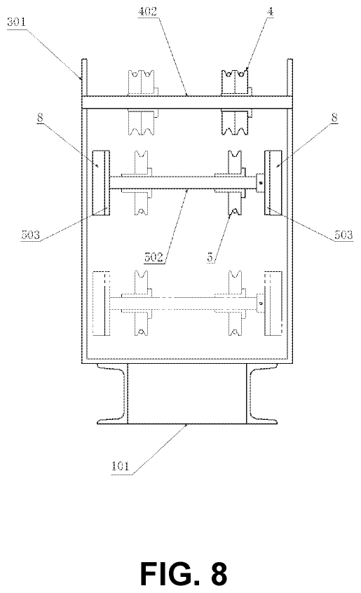

Referring to FIG. 8, instead of the two rodless cylinders 6 depicted in FIG. 6, two weights 8 are arranged in FIG. 8.

The operation of the above-described device will be described below.

When the tension of the wire rope 2 increases, the increase of the tension overcomes the action of the weight 8 and thus the distance between the pulleys decreases. When the distance between the pulleys decreases, the upper limit switch 7 operates, and when the limit switch 7 operates, the winch unit 1 rewinds the wire rope 2. Thus, due to the unwinding action of the wire rope, the weight 8 increases the distance between the pulleys;

On the other hand, when the tension of the wire rope 2 decreases, the weight 8 increases the distance between the pulleys due to the decrease in the tension. When the distance between the pulleys increases, the lower limit switch 7 operates, and when the limit switch 7 operates, the winch unit 1 pulls the wire rope 2. Thus, the distance between the pulleys decreases due to the wire rope pulling action;

By repeatedly performing the above wire rope returning operation and wire rope pulling operation due to the operation of the upper and lower limit switches 7, the tension of the wire rope 2 can be controlled to the constant tension.

The winch device having the auto-tension function is provided by the configuration and operation of the device of the first preferred embodiment according to the present invention as described above.

The force by which the weight 8 increases the distance between the pulleys is smaller than the force by which the winch unit 1 decreases the distance between the pulleys.

As for the force by which the weight 8 increases the distance between the pulleys, the weight of the weight 8 is preset.

Hereinafter, the second preferred embodiment of the apparatus constituted according to the present invention will be described with reference to the accompanying drawings.

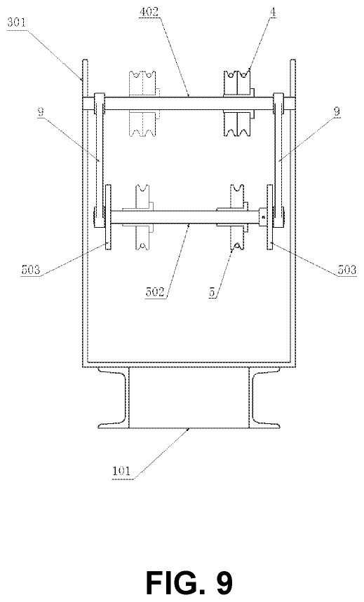

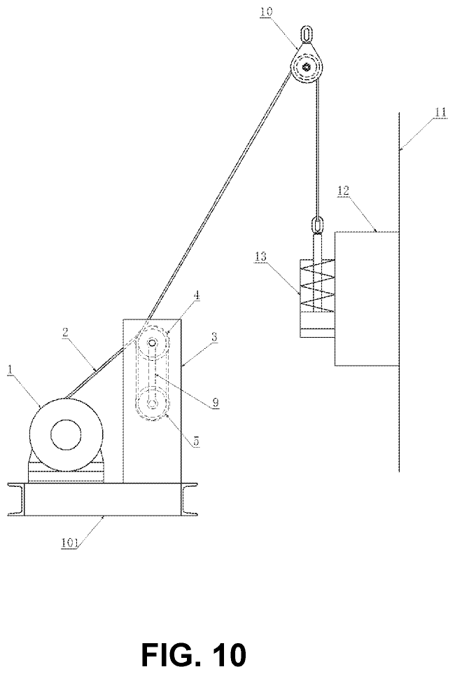

Referring to FIGS. 9 to 10, instead of the two rodless cylinders 6 depicted in FIG. 6, two load cells 9 are arranged in FIG. 9.

FIG. 10 shows the overall system configuration of the second preferred embodiment of the system constructed according to the present invention.

In FIG. 10, the compression coil spring for pushing is arranged in the expanded state inside the rod side of the cylindrical cylinder 13 with the piston rod.

The outer part of the cylindrical cylinder 13 is fixed to the known device 12, which adsorbs on the wall and is movable along it.

The end of the wire rope 2 is connected to the end of the rod.

In the control unit (not shown) of the load cell 9 shown, which is a kind of load sensor, the voltage proportional to the load is output.

In the control unit, the upper limit threshold and the lower limit threshold of the voltage are preset.

Therefore, when the load reaches the upper limit value or reaches the lower limit value, the signal indicating that the load is reached is output.

In the cylindrical cylinder 13 in which the compression coil spring is arranged, when the device 12 attracted to the wall surface and moving along the device 12 is stopped on the wall surface, first, the control unit of the load cell 9 outputs the lower limit value. Therefore, the winch unit 1 performs the winding operation. Therefore, in the figure, the compression coil spring is further compressed and the rod extends.

Next, due to the compression of the compression coil spring, that is, the increase in the tension of the wire rope 2, the control unit outputs the upper limit value. Therefore, the winch unit 1 is switched to the rewinding operation. After a while, on the contrary, the tension of the wire rope 2 starts to decrease, so that the compression coil spring is expanded and the rod is contracted in the figure.

After a while, the control unit outputs the lower limit value due to the extension of the compression coil spring, that is, the decrease in the tension of the wire rope 2, so that the winch unit 1 switches to the winding operation again.

After that, the cylindrical cylinder 13 with the piston rod repeats the extension and contraction of the rod due to the change in the tension of the wire rope 2. Therefore, the tension of the wire rope 2 is maintained at a substantially constant tension, irrespective of the operation on the wall surface of the device 12 that is attracted to the wall surface and moves along the wall surface.

The winch device having the auto-tension function is provided by the configuration and operation of the device of the second preferred embodiment according to the present invention as described above.

The effects of the preferred embodiment apparatus constructed in accordance with the present invention are described below.

The device of the preferred embodiment constructed in accordance with the present invention has the capability of automatically adjusting the tension of the rope so that the rope does not sag and the rope does not become overtight when the winch device is operating, a so-called has the auto-tension function.

The preferred embodiment apparatus constructed in accordance with the present invention is capable of converting a general-purpose commercially available winch device into the winch device having the auto-tension function at a low cost and in a short delivery time.

The limit switch 7 described above is a type of displacement sensor that detects displacement of the object, and is the “sensor that detects arbitrary displacement of the object”. It may be paraphrased as the “sensor that detects the threshold value of the displacement of the object”.

In the device constructed according to the present invention, the displacement sensor capable of continuously detecting the displacement of the object such as the rotary encoder can be used instead of the limit switch 7. In this case, the arbitrary “threshold value” is preset.

When the winch is the air winch using the air motor, the limit valve can be used as the “sensor for detecting an arbitrary displacement of an object”.

Although the preferred embodiment of the device of the present invention has been described above, the device of the present invention can be considered in various embodiments other than the preferred embodiment according to the scope of the claims.

As described above, the winch device having the function of automatically adjusting the tension of the rope so as not to loosen the rope and prevent the rope from being excessively tensioned while the winch device is operating, so-called the auto-tension function, as illustrated in the section “Background Technology”, it can be conveniently used as the device for preventing the fall of the adsorption self-propelled wall working robotic crawler that cleans or paints the wall surface of the oil storage tank, the hull, or the like.

Further, in the offshore vessel refueling system, various applications such as the winch device for stretching the wire rope while maintaining the constant tension between the traveling vessels can be considered.

What is claimed is:

1. A winch apparatus having automatic tension function comprising:
a winch unit having a rope pulling operation, a rope returning operation, and a rope stopping operation function;
at least two pulleys disposed between the winch unit and the towed object pulled by the winch unit through a rope, the pulleys having the rope suspended on the pulleys;
a pulley holding mechanism wherein one of the two pulleys is held by a pulley shaft via a pulley slide bearing, the pulley is rotatable by the function of the pulley slide bearing, and can slide freely along the pulley axis, and wherein the other of the two pulleys is held by another pulley shaft via a pulley slide bearing, the pulley is rotatable by the function of the pulley slide bearing, and can slide freely along the pulley axis, and wherein the distance between the two pulley axes is displaceable;
an actuator, a spring, or a weight disposed between the two pulley shafts, having a force for displacing a distance between the two pulley shafts in a direction in which the distance increases;
a rope that is suspended between the two pulleys such that as the tension of the rope increases, the distance between the two pulley axes decreases due to the increase in tension; and
a displacement sensor that detects changes in distance such as a position sensor that detects a change in the distance between the two pulley shafts, or a load sensor that detects a change in the distance between the two pulley shafts as a load change,
wherein when the tension of the rope increases, the distance between the pulleys decreases due to the increase in tension, and then the displacement sensor operates, thus causing the winch unit to return the rope, that is, the distance between the pulleys is increased due to the rope returning operation,
wherein when the tension of the rope decreases, the distance between the pulleys increases due to the decrease in the tension, and then the displacement sensor operates, thus causing the winch unit to pull the rope, that is, the distance between the pulleys is decreased due to the rope pulling operation,
that is, wherein the rope return operation and the rope pulling operation described above are repeatedly performed due to the operation of the displacement sensor, thereby controlling the tension of the rope to a constant tension.
